(19) United States
(12) Patent Application Publication
(10) Pub. No.: US 2025/0004733 A1
(43) Pub. Date: Jan. 2, 2025

(54) SYSTEM AND METHOD FOR IDENTIFYING UNTOUCHED SOURCE CODE SEGMENTS OF OPERATING SYSTEMS USING HARDWARE ASSISTANCE

(71) Applicant: VMWARE, INC., Palo Alto, CA (US)

(72) Inventors: Sunil Kumar Kotian, San Jose, CA (US); Adithya Uligere Narasimhamurthy, Longmont, CO (US)

(21) Appl. No.: 18/217,475

(22) Filed: Jun. 30, 2023

(51) Int. Cl. G06F 8/41

(52) U.S. Cl. CPC G06F 8/4435

(57) ABSTRACT

System and method for analyzing operating systems uses information regarding access bits set in page table entries to identify code segments of an operating system that were not executed. These code segments are identified by first identifying untouched memory pages using the information regarding the access bits in the page table entries, and then identifying functions of the operating system using physical memory addresses for the untouched memory pages. The identified functions represent the code segments of the operating system that were not executed.

### BACKGROUND

As operating systems evolve over time, the source code density of the operating systems grows due to the addition of new features, bug fixes and new platform support. Thus, as the software evolves, the old and legacy code sections remain as part of the operating system binary that is built and distributed. With the progress of time, it becomes hard to distinguish the code sections that actually run on a machine versus the code sections that never get executed, even though these code sections are built as part of the operating system. This can lead to increased system memory (RAM) usage when the operating system is loaded onto the memory, during the system boot up, and increased time to develop, build and maintain the source code of the operating system.

An additional fallout from these problems is that as the software evolution continues, the actual code sections of the operating system that get tested versus the actual code sections that get executed in a computer environment can diverge significantly. This could happen due to the fact that the test cases implemented within System Regression Testing (SRT) could be testing code paths that are not in use anymore and tend to evolve at a slower rate compared to the operating system development itself.

Thus, there is a need to detect the obsolete code sections that are present in the operating system binary so that they can be removed to (1) reduce time to build the operating system binary, (2) reduce total memory (RAM) usage for the binary during runtime, and (3) improve SRT quality by identifying the code sections that were run during SRT versus the code sections that execute in production environment, which can be used to develop targeted test cases to test the critical paths that were missed.

### SUMMARY

System and method for analyzing operating systems uses information regarding access bits set in page table entries to identify code segments of an operating system that were not executed. These code segments are identified by first identifying untouched memory pages using the information regarding the access bits in the page table entries, and then identifying functions of the operating system using physical memory addresses for the untouched memory pages. The identified functions represent the code segments of the operating system that were not executed.

A computer-implemented method for analyzing operating systems in accordance with an embodiment of the invention comprises, in response to a specified event, receiving information regarding access bits set in page table entries, wherein a memory page for which an access bit had been set is a memory page corresponding to a segment of an operating system that has been accessed by a processor and a memory page for which an access bit had not been set is a memory page corresponding to a segment of the operating system that has not been accessed by the processor, using the information regarding the access bits in the page table entries, identifying memory pages that have not been accessed by the processor as untouched memory pages, using physical memory addresses for the untouched memory pages, identifying functions of the operating system corresponding to the untouched memory pages that represent code segments of the operating system that were not executed, and performing an operation to improve the operating system based on the code segments of the operating system that were not executed. In some embodiments, the steps of this method are performed when program instructions contained in a computer-readable storage medium are executed by one or more processors.

A system in accordance with an embodiment of the invention comprises memory and at least one processor configured to, in response to a specified event, receive information regarding access bits set in page table entries, wherein a memory page for which an access bit had been set is a memory page corresponding to a segment of an operating system that has been accessed by a processor and a memory page for which an access bit had not been set is a memory page corresponding to a segment of the operating system that has not been accessed by the processor, using the information regarding the access bits in the page table entries, identify memory pages that have not been accessed by the processor as untouched memory pages, using physical memory addresses for the untouched memory pages, identify functions of the operating system corresponding to the untouched memory pages that represent code segments of the operating system that were not executed, and perform an operation to improve the operating system based on the code segments of the operating system that were not executed.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a distributed system in accordance with an embodiment of the invention.

FIG. 2 is a process diagram of a data read process in a host in the distributed system in accordance with an embodiment of the invention.

FIG. 3 is a process diagram of a data write process in a host in the distributed system in accordance with an embodiment of the invention.

FIG. 4 is a process flow diagram of an operation of identifying obsolete or unused code segments of an operating system (OS) in a host executed by a code execution analyzer in the distributed system in accordance with an embodiment of the invention.

FIG. 5 illustrates the distributed system with page crawlers in the hosts in accordance with an embodiment of the invention.

FIG. 6 is a process flow diagram of an operation of identifying obsolete or unused code segments of an OS in a host with a page crawler executed by the code execution analyzer in the distributed system in accordance with an embodiment of the FIG. 7 is a process flow diagram of an operation of detecting test escape code segments of an OS executed by the code execution analyzer in accordance with an embodiment of the invention.

FIG. 8 is a flow diagram of a computer-implemented method for analyzing operating systems in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

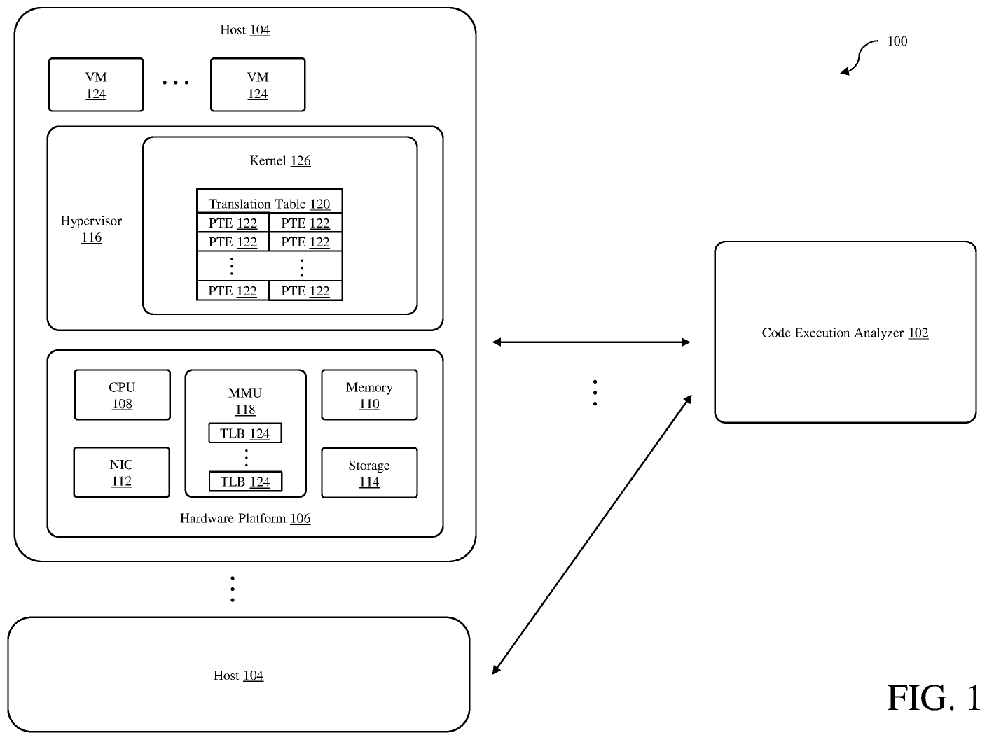

FIG. 1 illustrates a distributed system 100 in accordance with an embodiment of the invention. As shown, the distributed system 100 includes a code execution analyzer 102 and a number of host computers 104, which are sometimes referred to herein as “hosts”. As described in more detail below, the code execution analyzer 102 operates to identify parts of operating systems (OSs) running in the hosts 104 that are relevant, i.e., used during operation, or obsolete, i.e., not used during operation. In an embodiment, the obsolete code sections can be removed from future versions of the OSs, which can reduce time to build the operating system binary and reduce total memory (RAM) usage for the binary during runtime. In addition, by comparing relevant and obsolete code sections during SRT and production runtime, the SRT quality can be improved by developing targeted test cases to test the critical paths that were missed during testing.

As illustrated in FIG. 1, each host 104 has a hardware platform 106, which includes hardware components commonly found in a physical computer system, such as one or more processors 108, one or more system memories 110, one or more network interfaces 112 and one or more local storage devices 114 (collectively referred to herein as “local storage”). Each processor 108 can be any type of a processor, such as a CPU commonly found in a server. In some embodiments, each processor may be a multi-core processor, and thus, includes multiple independent processing units or cores. Each system memory 110, which may be random access memory (RAM), is the volatile memory of the host. The network interface 112 is an interface that allows the host to communicate with a network, such as the Internet. As an example, the network interface may be a network adapter, such as a network interface card (NIC). Each local storage device 114 is a nonvolatile storage, which may be, for example, a hard disk drive (HDD), solid-state drive (SSD) or a magnetic disk.

Each host 104 may be configured to provide a virtualization layer that abstracts processor, memory, storage and networking resources of the hardware platform 106 into the virtual computing instances that run concurrently on the same host. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

These virtual computing instances, such as VMs, run on top of the virtualization layer, which is a software interface layer that enables sharing of the hardware resources of the host by the VMs. For VMs, the virtualization layer can be realized using a hypervisor 116. One example of the hypervisor 116 that may be used in the illustrated embodiment is a VMware ESXi™ hypervisor provided as part of the VMware vSphere® solution made commercially available from VMware, Inc. The hypervisor 116 may run on top of the operating system of the host or directly on the hardware components of the host. If the hypervisor 116 runs directly on the hardware components, i.e., a bare metal hypervisor, then the hypervisor can be viewed as an operating system (OS). For other types of virtual computing instances, the host may include other virtualization software platforms to support those virtual computing instances, such as Docker virtualization platform to support software containers. It is noted here that each virtual computing instance, e.g., a VM, may include a guest OS that runs on the VM, similar to any other OS that runs on a computer system.

As shown in FIG. 1, the hardware platform 106 further includes a memory management unit (MMU) 118, which translates virtual memory addresses to corresponding physical memory addresses used in the memory 110. The MMU 118 uses an in-memory translation table 120 that includes page table entries (PTEs) 122, where one PTE corresponds to a particular memory page to map virtual page numbers to physical page numbers in the memory 110. In order to reduce the time to access a user memory location, the MMU uses memory caches called translation lookaside buffers (TLBs) 124 that store the recent translations of virtual memory addresses to physical memory addresses. In the illustrated embodiment, the translation table 120 is included in a kernel 126.

The translation of the virtual memory addresses to the physical memory addresses is needed when read and write processes are performed. As explained below, when memory pages are accessed, access bits may be set in the PTEs for the memory pages. These access bits can then be used to determine code segments of the OS, which may be the hypervisor 116, that have never been touched or executed by the CPU 108. These untouched code segments of the OS can be viewed as being obsolete and removed from the OS binary.

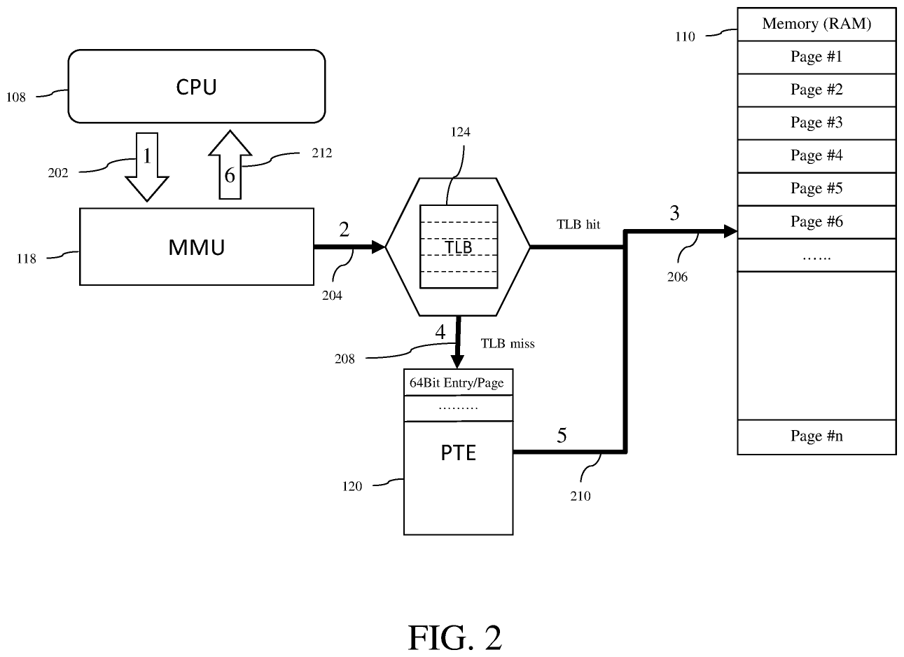

A data read process in the host 104 in accordance with an embodiment of the invention is described with reference to a process diagram of FIG. 2, which shows the various components of the host involved in the read process. These components include the CPU 108, the MMU 118, the TLBs 124, the translation table 120 and the memory 110. The data read process begins at step 1, as indicated by the arrow 202, where a read request for a virtual memory address is issued by the CPU 108. Next, at step 2, as indicated by the arrow 204, the TLBs 124 are looked up by the MMU 118 to see if the physical memory address to virtual memory address (PA-to-VA) mapping is present in the cache for the requested virtual memory address.

If the PA-to-VA mapping is present (i.e., a TLB hit), then the process proceeds to step 3, as indicated by the arrow 206, where a read operation is issued by the MMU 118 to the physical memory address of the memory 110 that is present in the found PTE entry 122 for the requested virtual memory address.

If the PA-to-VA mapping is not present (i.e., a TLB miss), then the process proceeds to step 4, as indicated by the arrow 208, where a page table walk is performed by the MMU 118 to figure out the PTE entry for the requested virtual memory address. That is, the PTE entries 122 in the translation table 120 are searched to find the PTE entry with the requested virtual memory address. In the illustrated embodiment, each PTE entry is 64 bits long. Next, at step 5, as indicated by the arrow 210, once the PTE entry is found, a read operation is issued by the MMU 118 for the physical memory address of the memory 110 corresponding to the requested virtual memory address that is present in the found PTE entry. The side effect of this operation is that an existing TLB entry can be evicted to place the newly found PTE entry such that future translation of this virtual memory address can be done faster.

Next, at step 6, as indicated by the arrow 212, the data in the memory 110 corresponding to the read request is transmitted to the CPU 108 to complete the data read process.

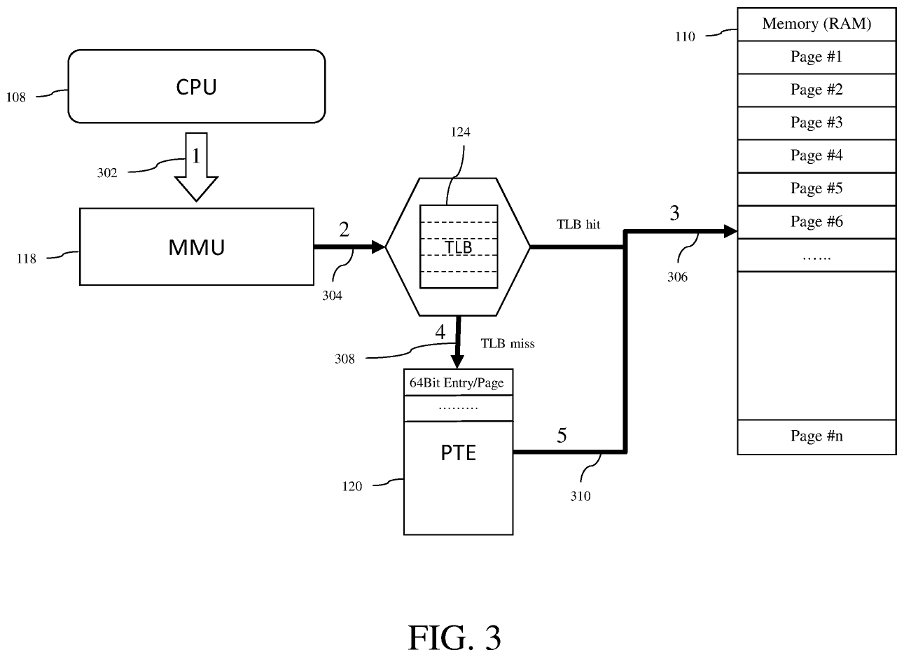

A data write process in the host 104 in accordance with an embodiment of the invention is described with reference to a process diagram of FIG. 3, which again shows the various components of the host involved in the write process. These components include the CPU 108, the MMU 118, the TLBs 124, the translation table 120 and the memory 110. The data write process begins at step 1, as indicated by the arrow 302, where a write request for a virtual memory address is issued by the CPU 108. Next, at step at step 2, as indicated by the arrow 304, the TLBs 124 are looked up by the MMU 118 to see if the PA-to-VA mapping is present in the cache for the requested virtual memory address.

If the PA-to-VA mapping is present (i.e., a TLB hit), then the process proceeds to step 3, as indicated by the arrow 306, where a write operation is issued by the MMU 118 to the physical memory address of the memory 110 that is present in the found PTE entry 122 for the requested virtual memory address.

If the PA-to-VA mapping is not present (i.e., a TLB miss), then the process proceeds to step 4, as indicated by the arrow 308, where a page table walk is performed by the MMU 118 to figure out the PTE entry for the requested virtual memory address. That is, the PTE entries 122 in the translation table 120 are searched to find the PTE entry with the requested virtual memory address. Next, at step 5, as indicated by the arrow 310, once the PTE entry is found, a write operation is issued by the MMU 118 for the physical memory address of the memory 110 corresponding to the requested virtual memory address that is present in the found PTE entry. Again, the side effect of this operation is that an existing TLB entry can be evicted to place the newly found PTE entry such that future translation of this virtual memory address can be done faster.

When a particular page (both code and data) is accessed by the CPU 108, certain CPU architectures (e.g., Intel CPU architectures) set a few bits within the PTE for that page to indicate that it has touched the page. This can give hints to the operating system (OS), indicating which pages are being affected because of the current code execution. The specific bits relevant to identifying pages that have been affected by OS operation are:
A bit: This is the access bit and indicates that the CPU has accessed this page recently.
D bit: This is the dirty bit and indicates that the CPU has written to this page and the page is currently dirty.

Note that this is only applicable to pages that contain data segments and does not apply to the pages that contain kernel code. The software developer's manual for a processor by Intel provides a detailed explanation of how each 64 bit PTE is organized in a page table and is provided below for reference. Intel also mentions that these bits are sticky, which means the CPU will not clear them once they are set.

The following table shows PTE entry breakup. This table is from Intel® 64 and IA-32 Architectures Software Developer's Manual, Order Number: 325462-077US April 2022).

| Bit Position(s) | Contents |
|---|---|
| 0 (P) | Present; must be 1 to map a 4-Kbyte page |
| 1 (R/W) | Read/write; if 0, writes may not be allowed to the 4-Kbyte page |
| | referenced by this entry (see Section 4.6) |
| 2 (U/S) | User/supervisor; if 0, user-mode accesses are not allowed to the 4-Kbyte |
| | page referenced by this entry (see Section 4.6) |
| 3 (PWT) | Page-level write-through; indirectly determines the memory type used to |
| | access the 4-Kbyte page referenced by this entry (see Section 4.9.2) |
| 4 (PCD) | Page-level cache disable; indirectly determines the memory type used to |
| | access the 4-Kbyte page referenced by this entry (see Section 4.9.2) |
| 5 (A) | Accessed; indicates whether software has accessed the 4-Kbyte page |
| | referenced by this entry (see Section 4.8) |
| 6 (D) | Dirty; indicates whether software has written to the 4-Kbyte page |
| | referenced by this entry (see Section 4.8) |
| 7 (PAT) | Indirectly determines the memory type used to access the 4-Kbyte page |
| | referenced by this entry (see Section 4.9.2) |
| 8 (G) | Global; if CR4.PGE = 1, determines whether the translation is global |
| | (see Section 4.10); ignored otherwise |
| 10:9 | Ignored |
| 11 (R) | For ordinary paging, ignored; for HLAT paging, restart (if 1, linear- |
| | address translation is restarted with ordinary paging) |
| (M-1):12 | Physical address of the 4-Kbyte page referenced by this entry |
| 51:M | Reserved (must be 0) |
| 58:52 | Ignored |
| 62:59 | Protection key; if CR4.PKE = 1 or CR4.PKS = 1, this may control the |
| | page's access rights (see Section 4.6.2); otherwise, it is ignored and not |
| | used to control access rights |
| 63 (XD) | If IA32_EFER.NXE = 1, execute-disable (if 1, instruction fetches are not |
| | allowed from the 4-Kbyte page controlled by this entry: see Section 4.6); |
| | otherwise, reserved (must be 0) |

The code execution analyzer 102 of the distributed system 100 uses the information contained in the access bits for memory pages in the PTEs 122 to determine which memory pages are being affected because of the current code execution. As described below, the code execution analyzer 102 operates to obtain access bit information for memory pages to identify the memory pages that were not accessed by the CPU 108. The physical memory addresses of these memory pages can then be used to identify the code segments of the OS that have not been executed by the CPU. These code segments can then be viewed as being obsolete code segments, which can be removed from versions of the OS. In an embodiment, the code execution analyzer 102 may be software running on any computer system, including any virtual computing instance, such as a VM.

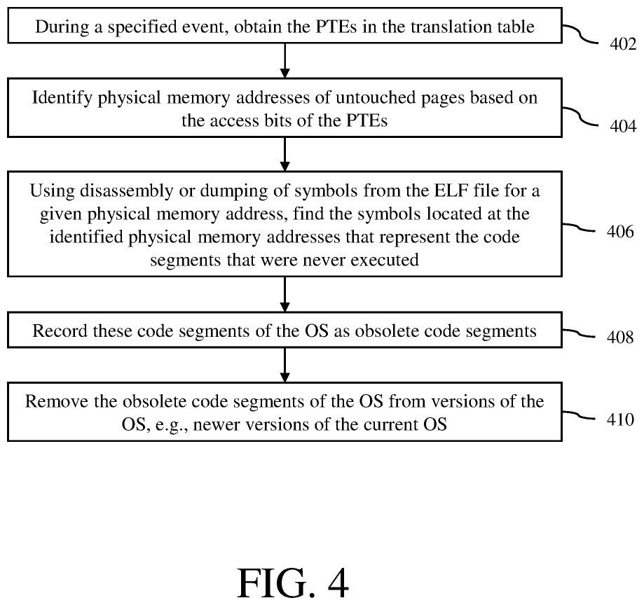

An operation of identifying obsolete or unused code segments of the operating system (OS) in one of the hosts 104 executed by the code execution analyzer 102 in accordance with an embodiment of the invention is described with reference to a process flow diagram of FIG. 4. This operation is applicable for an OS that does not clear the access bit for every PTE. The operation begins at step 402, where, during a specified event, the PTEs 122 in the translation table 120 are obtained by the code execution analyzer 102. The specified event may be a system shutdown or crash of the OS. In an embodiment, the PTEs may be dumped to the code execution analyzer 102. Since the OS does not clear the access bit for every PTE, the pages for which the access bit is not set are pages that were never touched by the CPU 108. In other words, these pages were never read in for execution, which can be used to identify untouched code segments of the OS.

Next, at step 404, physical memory addresses of untouched pages are identified by the code execution analyzer 102 based on the access bits in the PTEs. Next, at step 406, using disassembly or dumping of symbols from the executable and linkable format (ELF) file for a given physical memory address, the symbols located at the identified physical memory addresses are found by the code execution analyzer 102. The symbols in the ELF file correspond to variables and functions, and the found functions represent the code segments that were never executed by the OS for a given run and workloads.

Next, at step 408, these code segments of the OS are recorded by the code execution analyzer 102 as obsolete code segments. Next, at step 410, the obsolete code segments of the OS are removed from versions of the OS, e.g., newer versions of the current OS.

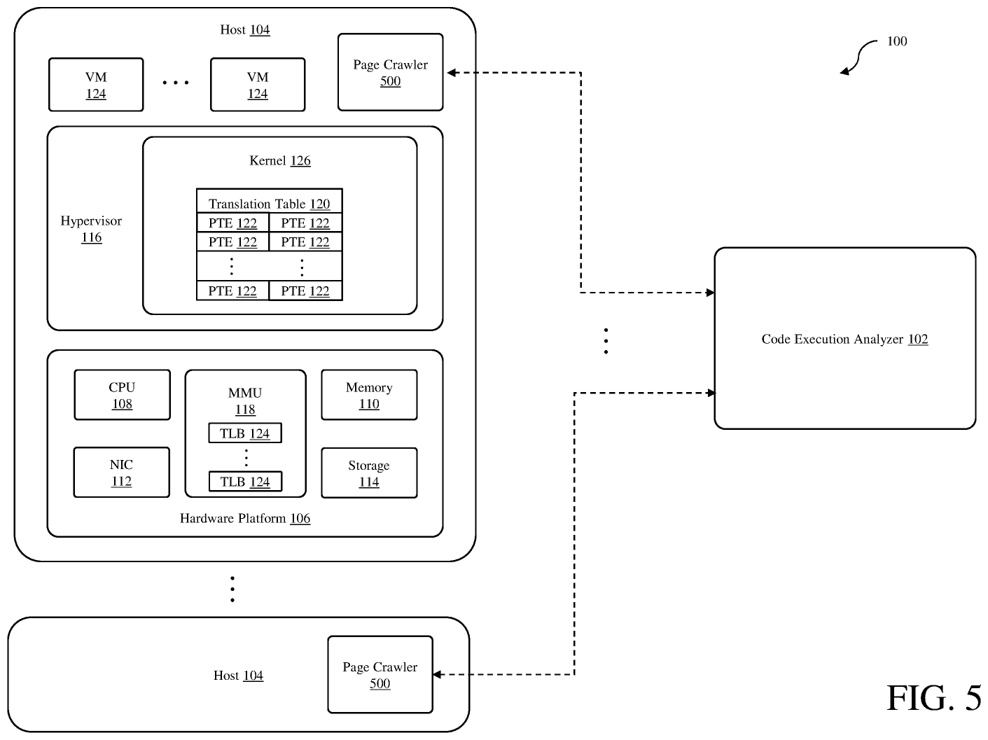

The above operation only works for an OS that does not clear the access bit for every PTE. For an OS that clears the access bit for every PTE when there is system shutdown or crash of the OS, a different operation is needed, where a page crawler monitors and records the clearing of the access bit for every PTE. A page crawler 500 in accordance with an embodiment of the invention is illustrated in FIG. 5. Although the page crawler 500 is shown as being outside of the kernel 126 of the hypervisor 116, the page crawler 500 may run in the kernel 126 in some embodiments.

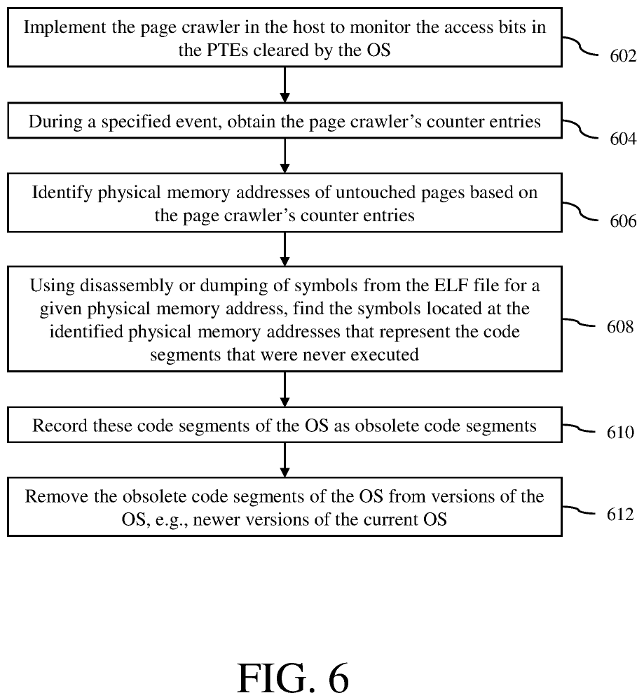

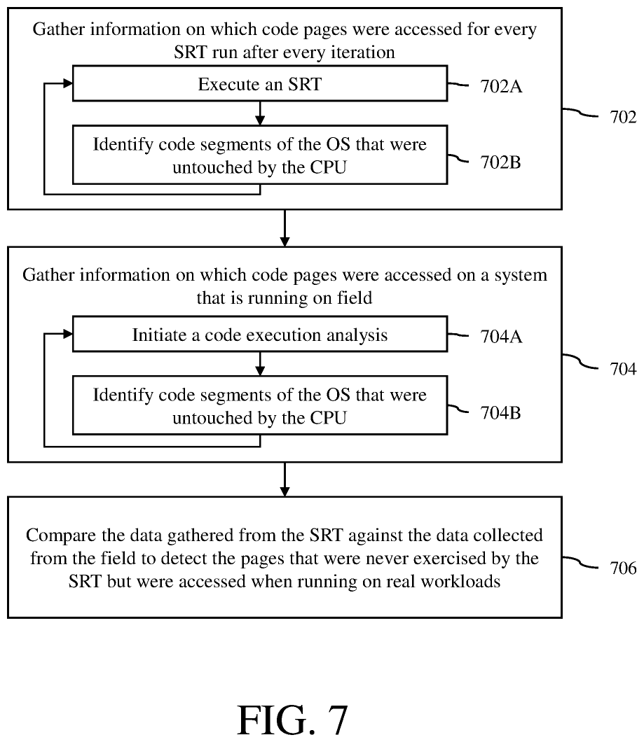

An operation of identifying obsolete or unused code segments of the OS in one of the hosts 104 with the page crawler 500 executed by the code execution analyzer 102 in accordance with another embodiment of the invention is described with reference to a process flow diagram of FIG. 6. This operation is applicable for an OS that does clear the access bit for every PTE during certain events. The operation begins at step 602, where the page crawler 500 is implemented in the host 104 to monitor the access bits in the PTEs cleared by the OS. In an embodiment, the page crawler 500 has a counter associated for every page that contains kernel code. When implemented, the page crawler 500 counts the number of times the access bit was cleared for a given page and increments the count for the corresponding page by one (1). In an embodiment, when the OS clears the access bit for a given page, the OS calls a page crawler's counter increment function to increment the count by one (1).

Next, at step 604, during a specified event, the page crawler's counter entries are obtained by the code execution analyzer 102. The specified event may be a system shutdown or crash of the OS. The page crawler's counter entries may be dumped to the code execution analyzer 102. In an embodiment, the page crawler's counter entries provide the physical memory address of each page and the number of times it was accessed. Thus, if the counter is zero for a page, then that page was never accessed, i.e., never touched by the CPU 108. In other words, the memory page was never read in for execution. Thus, the counter entries from the page crawler 500 can be used to identify untouched code segments of the OS.

Next, at step 606, the physical memory addresses of the untouched pages are identified by the code execution analyzer 102 based on the page crawler's counter entries. Next, at step 608, using disassembly or dumping of the symbols from the ELF file for a given physical memory address, the symbols located at the identified physical memory addresses are found by the code execution analyzer 102. The symbols in the ELF file correspond to variables and functions, and the found functions represent the code segments that were never executed by the OS for a given run and workloads.

Next, at step 610, these code segments of the OS are recorded by the code execution analyzer 102 as obsolete code segments. Next, at step 612, the obsolete code segments of the OS are removed from versions of the OS, e.g., newer versions of the current OS.

The approach described above to identify segments of the OS code that were never executed by the CPU can be used to detect “test escapes” for the code sections that would not be exercised by System Regression Testing (SRT). As used herein, “test escapes” are memory pages that were never accessed or executed by the CPU during SRT, but were accessed during normal operations on actual workloads. The identification of these test escapes can then be used to improve the SRT over time.

An operation of detecting test escape code segments of an OS executed by the code execution analyzer 102 in accordance with an embodiment of the invention is described with reference to a process flow diagram of FIG. 7. In some embodiments, this operation may be executed after either of the operations of identifying obsolete code segments of an OS, as illustrated in FIGS. 4 and 5. In other embodiments, this operation may be executed as a standalone operation, i.e., without one of the operations of identifying obsolete code segments of an OS being executed.

The operation begins at step 702, where information on which code pages were accessed for every SRT run is gathered after every iteration. Step 702 includes substeps 702A and 702B, which are repeatedly performed, as needed. At substep 702A, an SRT is executed on the OS. Next, at substep 702B, after the SRT has finished, code segments of the OS that were untouched by the CPU, e.g., the CPU 108, are identified. Depending on whether the OS clears the access bit for every PTE or not, substep 702B may be similar to the operation of identifying obsolete code segments of an OS, as illustrated in FIG. 4 or FIG. 5. The code pages for which the access bit is set indicate the pages that were touched (or executed) by the CPU for the current iteration of the SRT. These accessed pages show one or more functionalities that were exercised by the SRT during that test run.

Next, at step 704, information on which code pages were accessed on a system that is running on field, i.e., a system running real workloads, is gathered. Step 704 includes substeps 704A and 704B, which are repeatedly performed, as needed. At substep 704A, a code execution analysis is initiated on the OS by the code execution analyzer 102. The code execution analysis is the operation of identifying obsolete or unused code segments of the OS. Next, at substep 704B, after the code execution analysis has been initiated, code segments of the OS that were untouched by the CPU, e.g., the CPU 108, are identified. In an embodiment, the PTE information for the entire kernel code section is gathered to identify the OS code. Depending on whether the OS clears the access bit for every PTE or not, substep 704B may be similar to the operation of identifying obsolete code segments of an OS, as illustrated in FIG. 4 or FIG. 5. The code pages for which the access bit is set indicate the pages that were touched (or executed) by the CPU. These accessed pages show one or more functionalities that were executed by the OS during real workload execution. In an embodiment, substeps 704A and 704B may be repeated for different systems to perform the code execution analysis for different workloads or in different computing environments.

Next, at step 706, the data gathered from the SRT is compared against the data collected from the field to detect the pages that were never exercised by the SRT but were accessed when running on real workloads. Thus, these code pages, or “test escape” pages, are the pages that contain code segments, which are not currently exercised by the SRT, but are not obsolete or unused code segments. Thus, the results of the comparison, i.e., the pages that were touched on the field, but were never exercised by the SRT, may be used to develop targeted test cases to exercise the code segments that were previously not exercised, and consequently, filling the gaps that exist in the SRT. Thus, the SRT can be continuously improved using this mechanism to strengthen the SRT over time.

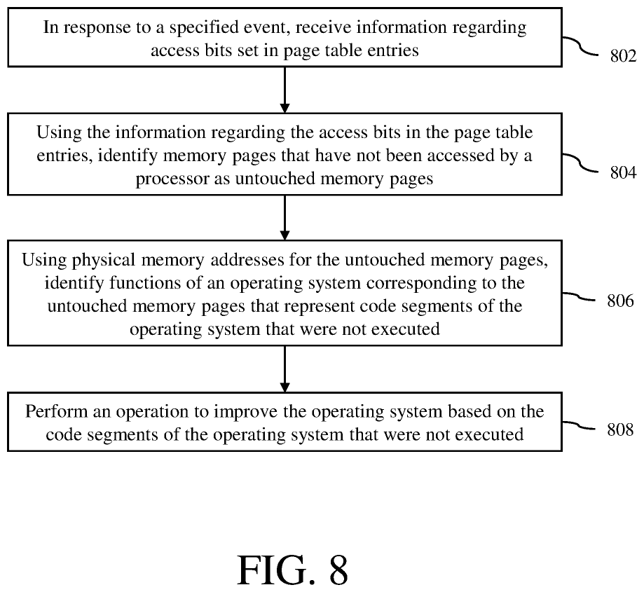

A computer-implemented method for analyzing operating systems in accordance with an embodiment of the invention is described with reference to a flow diagram of FIG. 8. At block 802, in response to a specified event, information regarding access bits set in page table entries is received. In an embodiment, a memory page for which an access bit had been set is a memory page corresponding to a segment of an operating system that has been accessed by a processor, and a memory page for which an access bit had not been set is a memory page corresponding to a segment of the operating system that has not been accessed by the processor. At block 804, using the information regarding the access bits in the page table entries, memory pages that have not been accessed by the processor are identified as untouched memory pages. At block 806, using physical memory addresses for the untouched memory pages, functions of the operating system corresponding to the untouched memory pages that represent code segments of the operating system that were not executed are identified. At block 808, an operation to improve the operating system is performed based on the code segments of the operating system that were not executed.

The components of the embodiments as generally described in this document and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for analyzing operating systems, the method comprising:
in response to a specified event, receiving information regarding access bits set in page table entries, wherein a memory page for which an access bit had been set is a memory page corresponding to a segment of an operating system that has been accessed by a processor and a memory page for which an access bit had not been set is a memory page corresponding to a segment of the operating system that has not been accessed by the processor;
using the information regarding the access bits in the page table entries, identifying memory pages that have not been accessed by the processor as untouched memory pages;
using physical memory addresses for the untouched memory pages, identifying functions of the operating system corresponding to the untouched memory pages that represent code segments of the operating system that were not executed; and
performing an operation to improve the operating system based on the code segments of the operating system that were not executed.

2. The computer-implemented method of claim 1, wherein performing the operation includes removing the code segments from a version of the operating system.

3. The computer-implemented method of claim 1, wherein identifying the functions of the operating system includes obtaining symbols for the untouched memory pages from an executable and linkable format (ELF) file.

4. The computer-implemented method of claim 1, wherein receiving the information regarding the access bits includes obtaining the page table entries in a translation table in a kernel of a hypervisor.

5. The computer-implemented method of claim 1, wherein receiving the information regarding the access bits includes obtaining the information from a page crawler that monitors the access bits in the page table entries.

6. The computer-implemented method of claim 5, further comprising maintaining a counter for each memory page by the page crawler, wherein the counter is increased when access bits are A bits or D bits as defined in a software developer's manual for a processor.

7. The computer-implemented method of claim 1, further comprising comparing code segments of the operating system that were not executed during a System Regression Testing (SRT) with code segments of the operating system that were executed during normal operations, wherein performing the operation includes improving test cases of the SRT based on results of the comparing.

8. A non-transitory computer-readable storage medium containing program instructions for analyzing operating systems, wherein execution of the program instructions by one or more processors of a computer system causes the one or more processors to perform steps comprising:
in response to a specified event, receiving information regarding access bits set in page table entries, wherein a memory page for which an access bit had been set is a memory page corresponding to a segment of an operating system that has been accessed by a processor and a memory page for which an access bit had not been set is a memory page corresponding to a segment of the operating system that has not been accessed by the processor;
using the information regarding the access bits in the page table entries, identifying memory pages that have not been accessed by the processor as untouched memory pages;
using physical memory addresses for the untouched memory pages, identifying functions of the operating system corresponding to the untouched memory pages that represent code segments of the operating system that were not executed; and
performing an operation to improve the operating system based on the code segments of the operating system that were not executed.

9. The non-transitory computer-readable storage medium of claim 8, wherein performing the operation includes removing the code segments from a version of the operating system.

10. The non-transitory computer-readable storage medium of claim 8, wherein identifying the functions of the operating system includes obtaining symbols for the untouched memory pages from an executable and linkable format (ELF) file.

11. The non-transitory computer-readable storage medium of claim 8, wherein receiving the information regarding the access bits includes obtaining the page table entries in a translation table in a kernel of a hypervisor.

12. The non-transitory computer-readable storage medium of claim 8, wherein receiving the information regarding the access bits includes obtaining the information from a page crawler that monitors the access bits in the page table entries.

13. The non-transitory computer-readable storage medium of claim 12, wherein the steps further comprise maintaining a counter for each memory page by the page crawler, wherein the counter is increased when access bits are A bits or D bits as defined in a software developer's manual for a processor.

14. The non-transitory computer-readable storage medium of claim 8, wherein the steps further comprise comparing code segments of the operating system that were not executed during a System Regression Testing (SRT) with code segments of the operating system that were executed during normal operations, wherein performing the operation includes improving test cases of the SRT based on results of the comparing.

15. A system comprising:
memory; and
at least one processor configured to:
in response to a specified event, receive information regarding access bits set in page table entries, wherein a memory page for which an access bit had been set is a memory page corresponding to a segment of an operating system that has been accessed by a processor and a memory page for which an access bit had not been set is a memory page corresponding to a segment of the operating system that has not been accessed by the processor;
using the information regarding the access bits in the page table entries, identify memory pages that have not been accessed by the processor as untouched memory pages;
using physical memory addresses for the untouched memory pages, identify functions of the operating system corresponding to the untouched memory pages that represent code segments of the operating system that were not executed; and
perform an operation to improve the operating system based on the code segments of the operating system that were not executed.

16. The system of claim 15, wherein the at least one processor is configured to remove the code segments from a version of the operating system to perform the operation.

17. The system of claim 15, wherein the at least one processor is configured to obtain symbols for the untouched memory pages from an executable and linkable format (ELF) file to identify the functions of the operating system.

18. The system of claim 15, wherein the at least one processor is configured to obtain the page table entries in a translation table in a kernel of a hypervisor to receive the information regarding the access bits.

19. The system of claim 15, wherein the at least one processor is configured to obtain the information from a page crawler that monitors the access bits in the page table entries.

20. The system of claim 15, wherein the at least one processor is configured to compare code segments of the operating system that were not executed during a System Regression Testing (SRT) with code segments of the operating system that were executed during normal operations, wherein performing the operation includes improving test cases of the SRT based on results of the comparing.
